(19) United States
(12) Patent Application Publication
(10) Pub. No.: US 2017/0358218 A1
(43) Pub. Date: Dec. 14, 2017

(54) RUNWAY OPTIMIZATION SYSTEM AND METHOD

(71) Applicant: Global Infrastructure Management, LLC, New York, NY (US)

(72) Inventors: Erik Einset, Doylestown, PA (US); Glenn Johnson, Devon, PA (US)

(21) Appl. No.: 15/621,184

(22) Filed: Jun. 13, 2017

Related U.S. Application Data
(60) Provisional application No. 62/349,334, filed on Jun. 13, 2016.

(51) Int. Cl. G08G 5/00; G06N 99/00; G08G 5/02

(52) U.S. Cl. CPC G08G 5/0043; G08G 5/0082; G08G 5/02; G08G 5/0026; G06N 99/005

(57) ABSTRACT

Airport runway optimization may be achieved by tracking aircraft related data such as statistics and status, generating an ideal spacing information between aircraft or flight instructions utilizing tracked aircraft data, communicating the ideal spacing information or flight instructions between area control and tower control, and directing the aircraft in its descent or to take-off. In one embodiment, feedback data is tracked related to an actual spacing of various aircraft and compared to the generated ideal spacing information or flight instructions to identify potential areas for improved optimization.

### CROSS-REFERENCE TO RELATED APPLICATIONS

This application claims the benefit of priority of U.S. Provisional Patent Application Ser. No. 62/349,334 filed on Jun. 13, 2016, which is hereby incorporated by reference in its entirety.

### FIELD OF THE INVENTION

The present invention is generally related to a system and method for optimization of an airport runway. More particularly, this disclosure is related to optimizing spacing and timing of arrivals and departures of aircraft along an airport runway.

### BACKGROUND

Pilots, air traffic controllers and airport personnel have long required assistance when managing an airport runway as it relates to arriving and departing aircraft. Generally, airports incorporate a communication framework that includes human interaction and various forms of communication between the airport, pilot, and other personnel to direct and organize aircraft for landing and take-off procedures.

Air traffic controllers and local area controllers maintain an open line of communication to maintain the proper spacing between aircraft landing and take-off. The position and trajectory and other information related to various aircraft are currently tracked via radar systems and associated tracking software. The throughput capacity of a runway with arriving aircraft is directly a function of the ability to control the time spacing of arriving and departing aircraft. Currently, there are various tools that have been implemented to establish communication between the parties in an attempt to control the spacing of arriving and departing aircraft. However, these known communication models are often deficient in implementing a system to efficiently direct takeoffs and landings, especially during a high volume of traffic.

For example, the air traffic controllers may include personnel located at the airport tower which may be considered “Tower Control” as well as a local control center located at a distance from the airport which may be considered “Area Control.” Area Control personnel may be tasked with oversight and management of multiple airports and flight patterns within a generalized area while Tower Control personnel may be tasked with oversight and management of a single airport or runway. Tower Control, Area Control and the personnel on aircraft maintain communication to direct air traffic. Tower Control communicates to Area Control a desired or requested spacing distance between aircraft for landing while Area Control may communicate to a pilot directing him during the landing process. Under this model, during high volume times, aircraft may be placed in a queued holding pattern before being cleared to land. The position and trajectory of each arriving aircraft is variable. Tower Control provides Area Control with a requested spacing between arriving aircraft while Area Control directs pilots to begin descending.

However, this framework is primarily based on the estimation, selection, and implementation of the personnel of the Tower Control, Area Control, and the aircraft. This leaves room for human error, inefficiencies, and latent application especially when spacing between arrivals and departures are desired to be optimized during high volume times.

In a mixed mode runway operation, where take offs and landings occur along a common runway, it may be desirable to ensure that spacing between successive arriving aircraft is not longer than is necessary. In a normal operation, the time between arrivals may vary, even when there is a holding queue of airborne aircraft waiting to land. These queued aircraft may cause excessive noise in areas surrounding the runway. Provided is a system to reduce the risk of human error, latent direction, or other inefficiencies to better manage the spacing and timing of arriving and departing aircraft, and to control the location of noise on the ground in the vicinity of the airport.

### SUMMARY

Airport runway optimization may be achieved by tracking aircraft related data such as statistics and status, generating an ideal spacing information between aircraft utilizing the tracked aircraft data, selecting an ideal spacing order, communicating the ideal spacing information between area control and tower control, and directing the aircraft to either begin descent or to take-off. In one embodiment, feedback data is tracked related to an actual spacing of various aircraft and compared to the generated ideal spacing information to identify potential areas for improved optimization.

Provided is a system for optimizing the spacing and timing of arrival aircraft and departing aircraft along a runway. The optimization system includes a communication framework for communicating between a tower control, an area control, and a plurality of aircraft. A processor for generating a suggested distance spacing between at least one sequence of arriving aircraft and departing aircraft. A central database for monitoring arriving aircraft data and departing aircraft data, the central database is in communication with the processor. A graphical user interface for receiving input signals and displaying output signals wherein the processor generates the suggested distance spacing and displays the suggested distance spacing on the graphical user interface.

The suggested distance spacing may be selected by tower control and communicated to area control. Area control may receive the suggested distance spacing from tower control and direct at least one aircraft to begin descent towards the runway. Alternatively, tower control may direct at least one aircraft to begin take-off from the runway in accordance with the suggested distance spacing. The at least one sequence of arriving aircraft and departing aircraft may be Arriving-Departing-Arriving (ADA). Additionally, the sequence may be Arriving-Departing-Departing-Arriving (ADDA) or Arriving-Arriving (AA). The processor may analyze actual aircraft spacing data in comparison to the suggested distance spacing and generate a feedback comparison report on the graphical user interface.

Also provided is a method for optimizing the spacing of arrival aircraft and departing aircraft along a runway. The method includes the steps of generating, via an optimization system, at least one suggested distance spacing between at least one sequence of arriving and departing aircraft. A suggested distance spacing may be selected. The suggested distance spacing may be communicated to area control. Aircraft may be instructed to either begin descent to land along a runway or to take-off from the runway. Actual aircraft data may be tracked. The optimization system may analyze the actual aircraft data and compare it to the suggested distance spacing. A feedback comparison report may be generated.

In another embodiment, provided is an airport runway optimization system that may track aircraft related data such as statistics and status while allowing a user to select a target arrival time for at least one aircraft, along with at least one way point which the aircraft must pass near. An example of such a way point could be a specified finals joining point, but may also include other geographical points. The choice of the way point or way points may be made to control the location and/or dispersion of arriving aircraft noise near the airport. The system may generate flight instructions utilizing the tracked aircraft data. The flight instructions may include a desired speed and trajectory for the aircraft estimated for the aircraft to arrive at the target arrival time. The system may communicate the target arrival time and flight instructions between area control and tower control, and communicate the flight instructions to the aircraft. The aircraft may execute the flight instructions to simultaneously achieve the target arrival time and pass through the specified way point.

This optimization system includes a communication framework for communicating between a tower control, an area control, and a plurality of aircraft. A processor for generating flight instructions for target arrival times and way points for at least one arriving aircraft. A central database for monitoring arriving aircraft data and departing aircraft data, the central database is in communication with the processor. A graphical user interface for receiving input signals and displaying output signals wherein the processor generates flight instructions utilizing the tracked aircraft data wherein the flight instructions may direct at least one aircraft to achieve the target arrival time while also passing through the specified way point. The inputs, outputs, tracking data and flight instructions may be displayed on a graphical user interface.

Airport runway optimization may be achieved by tracking aircraft related data such as statistics and status, inputting a target arrival time, generating flight instructions for a plurality of aircraft utilizing the tracked aircraft data, communicating the target arrival times and flight instructions between area control and tower control, and directing the plurality of aircraft to execute the flight instructions. In one embodiment, the flight instructions are the desired speed and trajectory of the plurality of aircraft estimated to land at the target arrival time. In another embodiment, the flight instructions include directions to land or take off. Further, feedback data may be tracked related to actual aircraft data and compared to the generated target arrival times and aircraft spacing information to identify potential areas for improved optimization.

The target arrival time may be selected by tower control and communicated to area control. Area control may receive the target arrival time from tower control and direct at least one aircraft to implement flight instructions estimated to allow the plurality of aircraft to achieve the target arrival time while also passing through a specified way point. Alternatively, area control or tower control may direct at least one aircraft to begin descent to the runway in accordance with the target arrival time. The at least one sequence of arriving aircraft and departing aircraft may be Arriving-Departing-Arriving (ADA). Additionally, the sequence may be Arriving-Departing-Departing-Arriving (ADDA) or Arriving-Arriving (AA). The processor may analyze actual aircraft data in comparison to the target arrival times and generate a feedback comparison report on the graphical user interface.

### BRIEF DESCRIPTION OF THE DRAWINGS

The disclosed method and system may be better understood by reference to the following detailed description taken in connection with the following illustrations, wherein:

FIG. 1 is a schematic diagram of embodiments of a communication framework between parties for managing the operation of a runway in accordance with the present disclosure;

FIG. 2 is a schematic diagram of a communication framework for an optimization system for managing the operation of a runway in accordance with the present disclosure;

FIG. 3A is a flow chart of embodiments for an optimization system for managing the operation of a runway in accordance with the present disclosure;

FIG. 3B is a flow chart of embodiments of a feedback comparison for an optimization system for managing the operation of a runway in accordance with the present disclosure;

FIG. 4 illustrates two graphs that identifies spacing times between arriving and departing aircraft;

FIG. 5 is a flow chart of embodiments of a method for optimizing the operation of a runway in accordance with the present disclosure;

FIG. 6 is an embodiment of an interface for the optimization system;

FIG. 7A illustrates a graph that represents aircraft elevations and speeds measured from a reference way point a distance from the runway;

FIG. 7B illustrates a graph that represents aircraft time spacing and spacing distance measured from a reference way point a distance from the runway;

FIG. 8 illustrates a graph with aircraft related data that represents a plurality of final approach lines with way points for aircraft for managing the operation of a runway in accordance with the present disclosure; and

FIG. 9 illustrates a flow chart of embodiments of a method for optimizing the operation of a runway and arriving aircraft in accordance with the present disclosure.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Provided is a method and system configured to assist air traffic controllers to optimize the arrival and departure of successive aircraft to airport runways. The throughput capacity of a runway with arriving aircraft may generally be a function of the ability to control the time spacing of arriving aircraft and a desired or targeted arrival time. Use of the term aircraft may include any one or a plurality of aircraft vehicles, such as airplanes, helicopters, etc. The runway may be a single mode or mixed mode runway. A mixed mode operation is a runway with arrivals and departures while a single mode operation is a runway with either just arrivals or just departures.

An optimal time between arrivals may allow for the proper time for a single departure in a mixed mode runway, such as an Arrival, Departure, Arrival (ADA) sequence, two departures, such as an Arrival, Departure, Departure, Arrival (ADDA) sequence, or two arrivals, such as an Arrival, Arrival (AA) sequence. The ability to control timing and spacing of aircraft is particularly important in periods where there is a high volume of traffic, resulting in queuing, and the subsequent standard delivery of queued arrivals to final approach.

The system incorporates several elements that may be considered for delivering consistent and targeted spacing and times between arrivals (i) choosing the proper requested distance spacing between arriving aircraft (such as at four (4) nautical miles distance measurement equipment (DME) point), and (ii) instructing the pilot to begin descent or to join a final approach line/trajectory (iii) and executing the instruction by the pilot for achieving the requested spacing between aircraft and timing of arrivals and departures. The disclosed system may improve the communication, tracking, and implementation of these variables by ensuring that the tower controllers, area controllers and aircraft personnel adhere to a generated and trackable set of directions communicated and followed by each party.

Airport runway optimization may be achieved by tracking aircraft related data such as statistics and status, generating an ideal spacing information between aircraft utilizing the tracked aircraft data, communicating the ideal spacing information between area control and tower control, and directing the aircraft in their descent, or to take-off. In one embodiment, feedback data is tracked related to an actual spacing of various aircraft and compared to the generated ideal spacing information to identify potential areas for improved optimization.

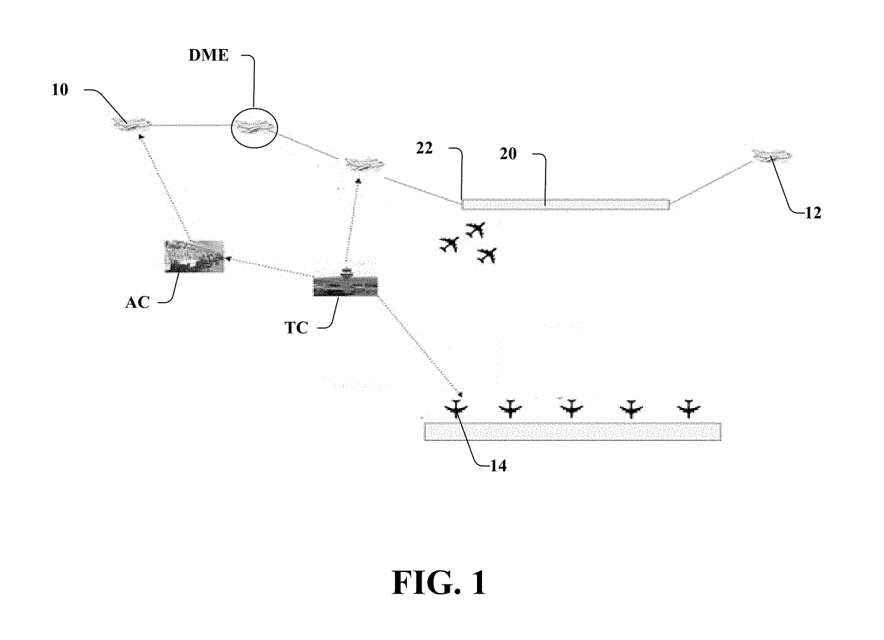

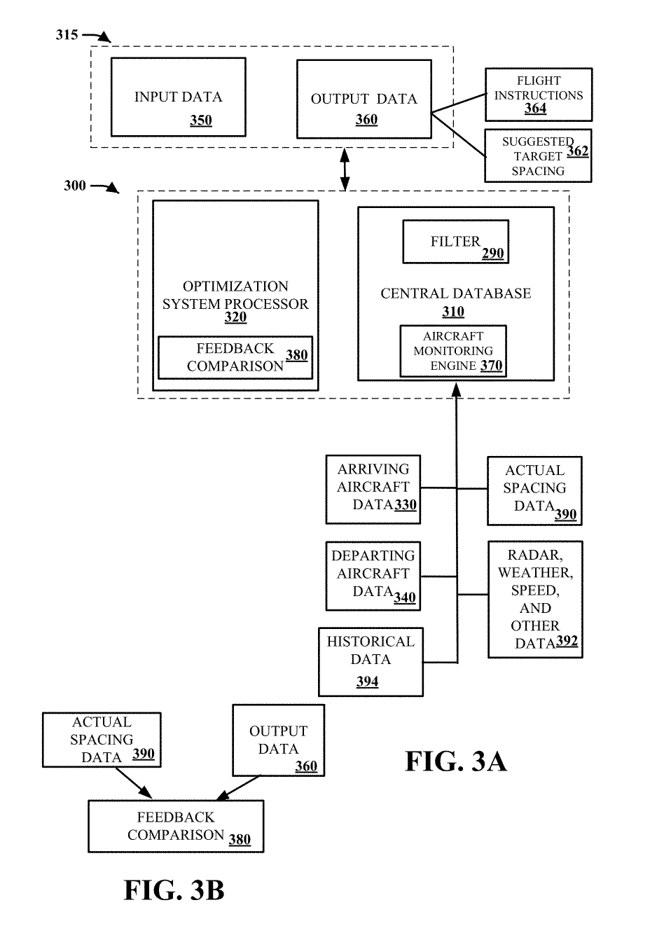

FIG. 1 illustrates a schematic diagram for the disclosed system. Here, the tower control (TC) may be a location near an airport that includes personnel to oversee and manage the operation of the airport runway 20. However, TC personnel do not have to be physically located at the airport but could also be in a remote location and operate using cameras physically located at the airport. Tower control TC has open lines of communication between the arriving aircraft 10, departing aircraft 12 as well as parked or taxiing aircraft 14. Additionally, tower control TC has an open line of communication with area control (AC). Area control AC may be located a distance away from the airport or runway 20, however, area control AC may include personnel that oversees and manages the operation of air traffic for multiple airports and runways in a given region. Tower control TC may have access to an optimization system 300 that may include a central database 310 that may track aircraft data and generate performance instructions (See FIG. 3). Area control AC may have open lines of communication between the arriving aircraft 10 as well as departed aircraft 12. Additionally, area control AC may have access to optimization system 300 and the central database 310 that may track aircraft data and generate performance instructions (See FIG. 3).

FIG. 1 illustrates as arriving aircraft 10 may be preparing to land on the landing strip 20. Area control AC typically provides aircraft 10 instruction as to when to change direction and speed based on the input received from tower control TC as well as other factors such as the weather.

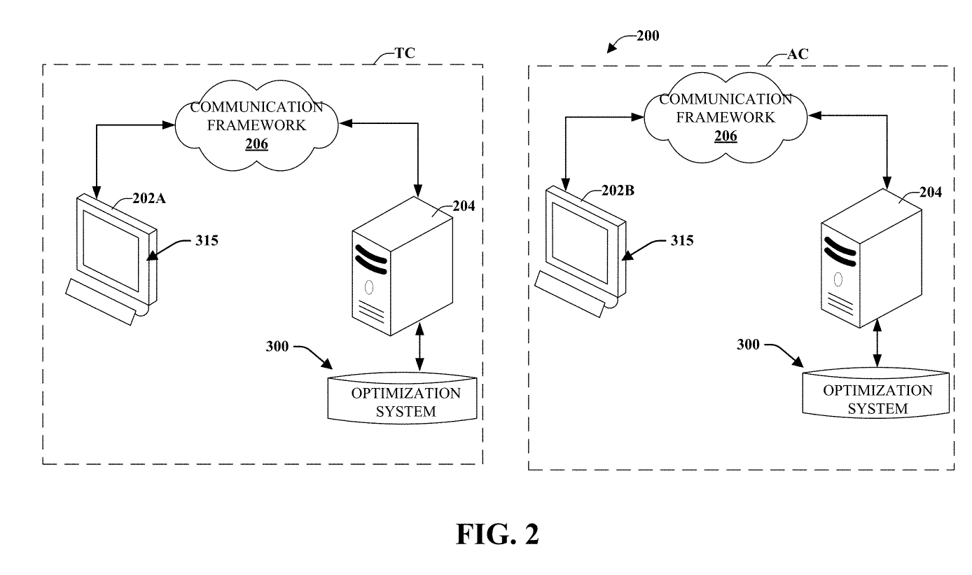

FIG. 2 illustrates the system architecture 200 that may implement the system and method of the present disclosure. In particular, the system architecture 200 allows tower control TC to communicate with area control AC such that information can be communicated and stored via the system architecture 200. The system may include a user display 202A accessible to personnel from tower control TC. The user display 202A may be in communication with a computer/processor 204 by way of a communication framework 206 such as the internet, network, Wi-Fi, radio transmission, or cloud as is generally known in the art. Additionally, a user display 202B may be accessible by the personnel of area control AC. The user display 202B may be in communication with a computer/processor 204 by way of the communication framework 206. The user displays 202A and 202B may allow personnel to access a graphical user interface 315 to interact with the optimization system 300 to track aircraft data and generate instructions. The system architecture 200 may include at least one tablet, LCD screen, smart screen, computer, laptop, voice communication device, etc.

The optimization system 300 as is generally illustrated by FIGS. 3A and 3B, may include a graphical user interface 315 to allow personnel to provide input data 350 and receive output data 360. The optimization system 300 may include a processor 320 in communication with a central database 310. The central database 310 may receive and store a variety of data as it relates to arriving aircraft 330 and departing aircraft 340. For example, the central database 310 may include data such as radar data, arriving aircraft performance data, departing aircraft performance data, measured speeds, aircraft elevations, as well as other measurable data such as weather information. Notably, the central database 310 may take in measured data, such as wind conditions (from weather sensors on the ground or on arriving aircraft), indicated airspeeds (from various radar systems such as Mode-S), ground speed (from radar tracks), aircraft type, and operator (pilot or aircraft personnel). The data may further include real time wind speed and wind direction along the flight path of an aircraft and in particular along the flight path of an aircraft as it is positioned or projected to be positioned along a final approach track or departure location along the runway. This data may be analyzed or processed by the processor 320 and compared with Mode-S data and radar data. The flight path data, wind speed data, wind direction data may be processed to provide a predictive model representative of a duration of time that it may take for a plane or multiple planes to travel from a particular reference point to runway touchdown. Further, the speed of the aircraft upon descent and at touchdown may also be analyzed to predict runway occupancy time.

Further, the central database 310 may include information such as aircraft type, airline carrier, and indicated airspeed profile along final approach (last 10 mi). Different aircraft may include different performance characteristics (e.g. a A320 is different from B757) as such various airline operators may have different operating practices. The database 310 may include a filter 290 that allows the database to store various operating processes and ranges of data, such as the airspeed profile of an aircraft along final approach that may be filtered through database filter 290 such as by airline operating processes or tracking a filtered distance of data at a distance of at least 5 km, 10 km, or 20 km, etc. This airspeed profile data along final approach may be stored and considered by the optimization system 300.

In an embodiment, the central database 310 may include information relating aircraft type, aircraft operator, wind speed and direction, runway direction, and a runway occupancy time (ROT). ROT may be described as the time a landed, or ready to take-off, aircraft will “own” the runway before they either exit the runway or go wheels up. Different aircraft may include different ROT and different airlines may have different operating processes that impact ROT. This ROT data may also be stored and considered by the optimization system 300. In a further embodiment, the central database 310 may include information such as aircraft type, load, airline operator, and duration of time a departing aircraft may be on the runway during a takeoff procedure. This duration of time may be filtered through the filter 290 to track and store information related to the time an aircraft begins takeoff from a reference point until the time aircraft wheels are up.

The processor 320 may analyze and process the information from the central database 310 to produce a predictive model illustrative of an aircraft or plurality of aircraft to predict touchdown times, a rate of turn of the aircraft, and the subsequent time for wheels up of the departing aircraft. Further, the predictive model may illustrate the ground speed velocity profile of trailing aircraft relative to leading aircraft to determine a location (such as a DME) and a point of time that the trailing aircraft may be directed to obtain the time of crossing the threshold DME at a particular amount of time (e.g. 30 or less seconds) after a departing aircraft wheels are up.

Historical data 394 related to the aircraft and the conduct of the operator or pilot may be tracked and stored at the central database 310. The data may be both currently sensed information as well as historical tracked and stored information. The optimization system processor 320 may be an application that is web based or stored onto a network or computer. The optimization system processor 320 may communicate with the central database 310 to perform functions that are communicated through the graphical user interface 315 at tower control TC, area control AC, or other remote location with network access. The system may be implemented to minimize variations in time between arrivals and minimize wasted runway time. The system may ensure that instructions and execution of the instructions by aircraft operators are performed in a consistent manner that may be tracked and analyzed.

In one embodiment, the optimization system 300 may generate an output signal 360 representative of a desired aircraft spacing measurement. This output signal 360 may then be illustrated on the graphical user interface 315 presented on the display 202A to be accessed by personnel at tower control TC or the display 202B to be accessed by personnel at area control AC. However, the output signal 360 is not limited to how it is communicated to either tower control TC and area control AC.

The optimization system 300 may allow for the live analysis of arrival aircraft with respect to relative distance and time based spacing, adherence to standard operating procedures, and airborne queuing times. The optimization system 300 may utilize data monitored and stored by the central database 310 to calculate suggested operating parameters to maximize the utilization of the airspace and the runway. The output signal 360 may be representative of a suggested ideal spacing distance 362 that is illustrated on the graphical user interface 315. In another embodiment, the output signal 360 may be flight instructions 364 communicated to an aircraft and will be discussed more fully below.

Various considerations may be taken into account for calculating the output data 360 (an ideal spacing between flights or a target landing time) including any one or a combination of, net wind effect on the aircraft, indicated aircraft airspeed, actual aircraft speed, ground speed, plane size, cargo load, plane type, angle of plane, ground conditions, altitude, pressure, and weather conditions. Weather conditions that may be taken into consideration include, but are not limited to, snow, rain, hail, wind, visibility, fog, humidity, weather incidents, sun, etc. The precise formula for calculating the output data 360 may further rely on flying tendencies or characteristics of the pilot. In one embodiment, the radar data may be sourced by various options and this disclosure is not limited to its sources of radar data. The radar data may be of sufficient quality to enable precise analysis by the processor 320. The flight data may include an indicated airspeed and a ground speed to allow wind effects to be offset when targeting a specific time between arrivals or between an arrival and a departure.

The optimization system 300 may receive input data 350 from personnel at tower control TC, the input data 350 may be representative of an aircraft spacing from a reference point (e.g. 4DME) or may be a target arrival time. The optimization system processor 320 may receive this input data 350 and be prompted to communicate with the central database 310.

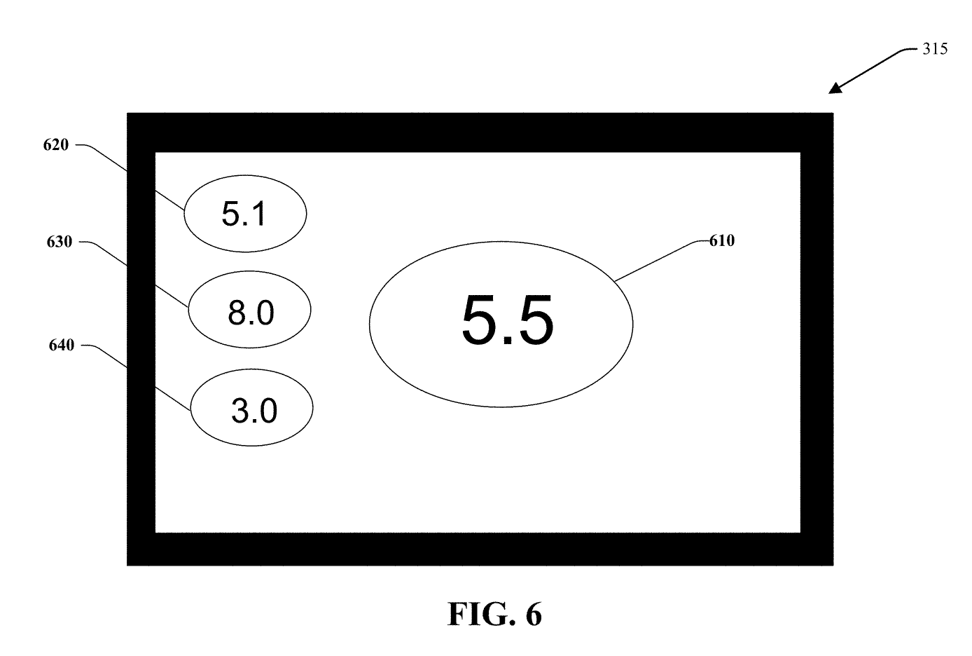

The central database 310 may continually be collecting data from the various identified data sources. The processor 320 may then generate an output signal or data 360 that identifies an aircraft spacing measurement 362 or suggested flight instructions 364 for arriving aircraft 10 at the runway 20. The processor 320 may perform statistical analysis in real-time to generate a continuously updated suggested target spacing 620 (See FIG. 6) to be displayed on the graphical user interface 315. The suggested target spacing 620 may be calculated with a filter 290 that may include standard deviations or error bounds based on input data or include various parameters input through the filter 290 of the central database 310. Alternatively, the processor 320 may perform statistical analysis in real-time to generate continuously updated flight instructions 364 that are calculated to allow the respective aircrafts to achieve the target arrival times. The flight instructions 364 may be calculated with the filter 290 that may include standard deviations or error bounds based on input data or include various parameters input through the filter 290 of the central database 310.

For every aircraft, the processor 320 may include logic that utilizes information including aircraft type, wind data, airline operator, actual spacing data, target arrival time, current time, aircraft speed, and aircraft path or trajectory data. The processor 320 and central database 310 may be continually updated with various data to be able to generate spacing and instructions with efficient use of time and space for every aircraft.

The processor 320 may be programmed with logic to incorporate safety standards to ensure that the suggested targeted spacing 620 is within safe operating conditions. The suggested targeted spacing 620 may be displayed on the graphical user interface 315 or presented to personnel at tower control TC in various ways. The personnel at tower control TC may then choose to elect to cause an operational change to the system and override the current target spacing 610. The selection of the suggested targeted spacing 620 may be made with a number entry tool, audibly, through touch, or by other pre-agreed operational procedure. In one embodiment, the display 202A at tower control TC may be a touch screen wherein personnel may select the suggested targeted spacing icon 620 and drag the icon over the current target spacing icon 610 on the graphic user interface 315. This input would effectively override the current target spacing 610 with the suggested target spacing 620. This override selection may be automatically communicated from tower control TC to area control AC via the communication architecture 200. Alternatively, tower control TC could elect to contact area control AC through telephone or other communication device to inform them of the operational change from the current target spacing 610 to the suggested target spacing 620. Notably, the processor 320 may also perform statistical analysis in real-time to calculate a continuously updated “suggested target spacing” for an ADDA 630, AA 640 or other arrival and departure sequences.

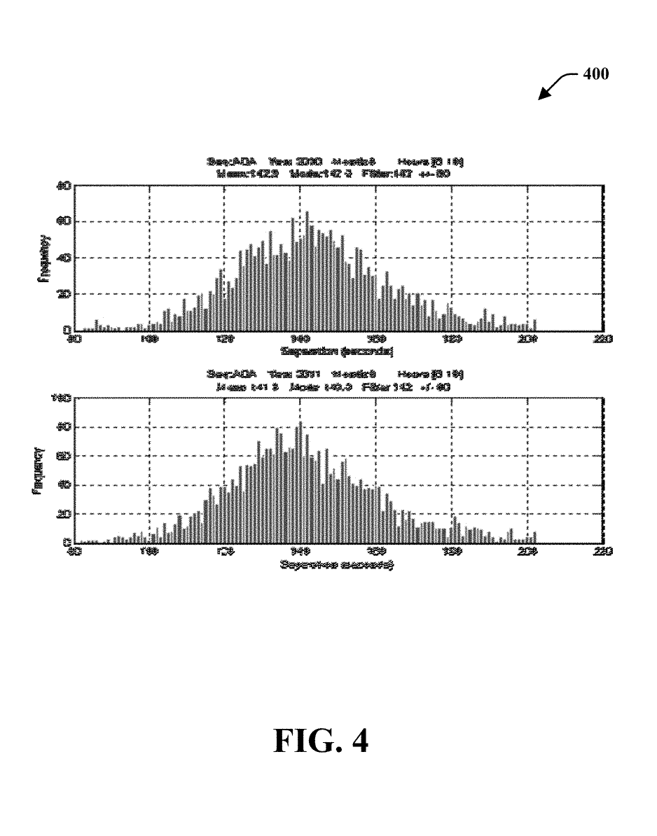

FIG. 4 illustrates two graphs 400 that identify the time separation between an actual lead and a trailing aircraft. The y-axis illustrates a frequency of occurrences and the x-axis represents the separation of aircraft as a function of time (seconds).

Once the input signal 350 (ie. suggested targeted spacing 620 or target arrival time) is selected by tower control TC personnel, the display 204B at area control AC may illustrate a similar graphical user interface 315 that identifies that a new value has been selected. Personnel from area control AC may then communicate to the various aircraft 10 at the appropriate times to ensure that the suggested targeted spacing/target arrival time is maintained. Alternatively, area control AC may merely instruct the queued aircraft 10 at the appropriate times in accordance with the generated output signal 360. Tower control TC may also communicate with departing aircraft 12, 14 to inform them of the order and time for take-off relative to the arriving aircraft 10.

In one embodiment, the target spacing 610, 620, 630, 640 may be representative of a distance between an approach marker DME (FIG. 1) as selected by personnel and a runway threshold location 22. The approach marker DME may be a flagged position, (ie. longitude and latitude point) relative to the threshold location 22 along runway 20. As an arriving aircraft 10 may be targeted to arrive at the approach marker, various data points may be measured. The target spacing information 610, 620, 630, 640 may be representative of the distance between the trailing aircraft when the leading aircraft reaches the threshold location 22 along runway 20. The spacing information may be in nautical miles. Additionally, when the leading aircraft 10 reaches the threshold location 22 on the runway 20, a time measurement may be recorded and the position of the trailing aircraft recorded. The time measurement and position measurement data may be utilized to generate the suggested optimal spacing output 620. The processor 320 may include a transfer function or algorithm to generate or predict a time to reach the runway from the approach marker DME that may be required for the optimal spacing of successive aircraft.

The display may show the spacing optimization in a number format as shown in FIG. 6. Also, the icons 630, 640 display alternate spacing of as such spacing is used for alternate arrival-departure-arrival of aircrafts. The graphic user interface 315 may include a variety of different input and output icons. This disclosure is not limited to the form or number of various input icons available as it may be configured or programmed as may be required for the individual personnel. The graphic user interface 315 may display a radar plot allowing personnel the ability to input data representative of a specific point/aircraft on the plot such that a pop-up or list of selected aircraft data may be displayed. This data may include aircraft registration, flight number, time, instructed performance, and actual performance.

In one embodiment, the displayed plot on the graphic user interface 315 may allow for queuing times of arriving aircraft. An area on a map may be selected as a “hold” area where moving aircraft will be identified and tagged when they enter the hold area, and tagged again when they leave the hold area. The time in that defined hold area may be linked to the aircraft information. The output data may be representative of a control chart of hold time vs. landing time or a histogram of holding time over a specified period of time.

In another embodiment, the graphical user interface may include a ‘clear’ icon (not shown) that may allow an operator to clear the displayed spacing optimization numbers, and an ‘enter’ icon (not shown) that may allow an operator to submit and communicate an entered command. On the screen, a display may show the time stamp, such as at the top left of the screen. In an embodiment, displays 202A, 202B may have a locked feature to lock the screen to avoid any accidental change in the display of the spacing optimization numbers. The locked feature may, for example, include a pass code.

The optimization system 300 may be able to capture a plurality of sequenced aircrafts in a row, such as over four sequenced aircrafts. The graphic user interface 315 may also illustrate a list of the airline company, aircraft type, and/or the aircraft's features for each aircraft. Features of the aircraft features may include an icon that represents the name, pilot experience, status, flight tendencies, plane style, etc. of each specific aircraft pilot and/or aircraft.

The optimization system 300 may continually track, monitor, and store each command or communication provided between the tower control TC, area control AC and aircrafts 10, 12, 14 to identify actual data. The tracked data may be arriving aircraft data 330, departing aircraft data 340, actual spacing data 390, radar, weather, speed, and other data 392 which may be compared to the output signal 360 provided at the time the suggested target spacing 362 or flight instructions 364 were selected. The optimization system 300 may include logic for a feedback comparison 380 to track human adoption of the optimization system 300 and to identify areas of inefficiencies, if any, between communication and implementation of the optimization system 300.

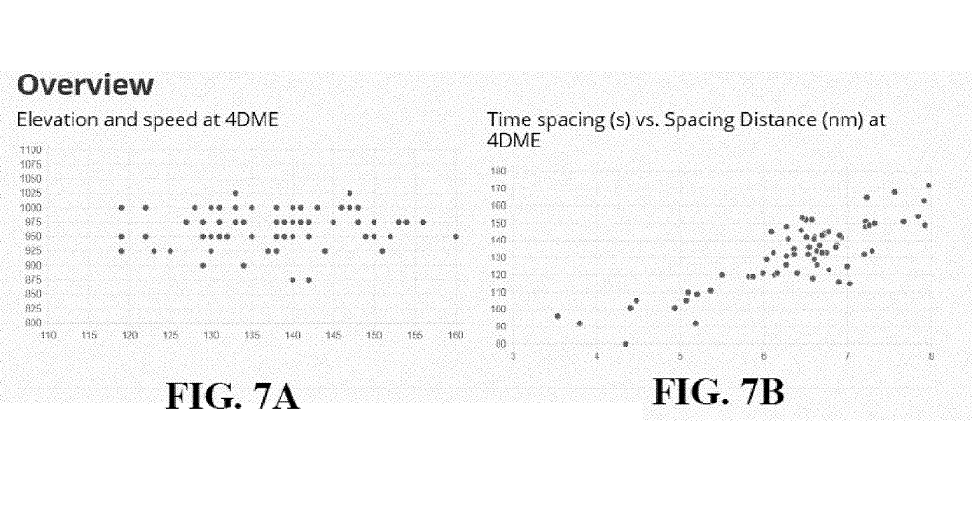

As illustrated by FIG. 3B, feedback comparison 380 may be made by comparing the actual spacing data 390 with the output signal 360 representative of the flight instructions 364 or the suggested target spacing 362. The feedback comparison 380 may be displayed to tower control TC to inform personnel of actual performance in achieving the requested spacing. The feedback comparison may be provided through an automated performance report that compares requested spacing to delivered spacing. This report may be in the form of a control chart, tabular, histogram, among others. FIGS. 7A and 7B illustrate various reports that indicate measured data from aircraft 10 as approaching a runway 20. These reports may be automatically generated and displayed to tower control TC, area control AC, or other network port via the optimization system 300. The feedback comparison output may be in the form of a regression plot that illustrates the time/distance of aircraft on the final approach, and a plot of the transfer function (with calculated error bars) to allow for the reading of required spacing at the approach marker to achieve a given time spacing at the runway.

Using this performance report, tower control TC may be able to identify aircraft performance as approaching the runway. Personnel may be able to adjust the logic of the processor 320 to assist with generating an ideal suggested target spacing related to the instruction of aircrafts in their transition to final approach.

The optimization system 300 may monitor the performance, log personnel requests, and track historical performance. For example, the central database 310 may include an aircraft monitoring engine 370 to record, track or register arriving aircraft data 330, departing aircraft data 340, actual spacing data 390 as well as radar, weather, speed, elevation, and other data such as base leg joining point and aircraft trajectory. The database 310 may monitor the number of aircraft that are processed through a runway 20 within a period of time. The monitoring of the performance could also be presented at the user display 202A, 202B at tower control TC to provide personnel with visibility to the information. Further, the aircraft monitoring engine 370 may be utilized by the feedback comparison feature to allow tower control TC to monitor aircraft compliance with the suggested target spacing 362 and flight instructions 364. It could identify if failure of compliance with the output data 360 may be the result of latent instructions, instructions that could not be carried out, or ignored instructions.

The optimization system 300 may capture the actual spacing of tracked aircraft 10 and provide communication between area control and tower control. The optimization system 300 may drive adoption of a standard operating procedure to implement the optimal spacing and a target arrival time. The optimization system 300 may be customized for each aircraft 10 and may allow tower control TC to be more aggressive in reducing the spacing in a safe operation of traffic control. The optimization system 300 may be designed to reduce the variance in seconds from a time of a departing aircraft wheels are up and a trailing aircraft is crossing a threshold DME. As this time variance may be reduced, the average time between arriving and departing aircraft may be reduced. Further, the system may be tuned to achieve an acceptable low frequency to maximize runway throughput.

The feedback comparison 380 feature allows for post-flight review of information relating to the flight journey. In one embodiment, the feedback comparison 380 may be used to gauge performance of personnel at tower control TC, area control AC or pilots in their effort to achieve spacing between aircrafts via the automated performance report that compares requested spacing to delivered spacing (plots of actual positions, speeds, elevations). This report may be in the form of a control chart, tabular, histogram, among others. Using this performance report, tower control TC may be able to adjust their decision making of instructing aircrafts in their transition to final approach.

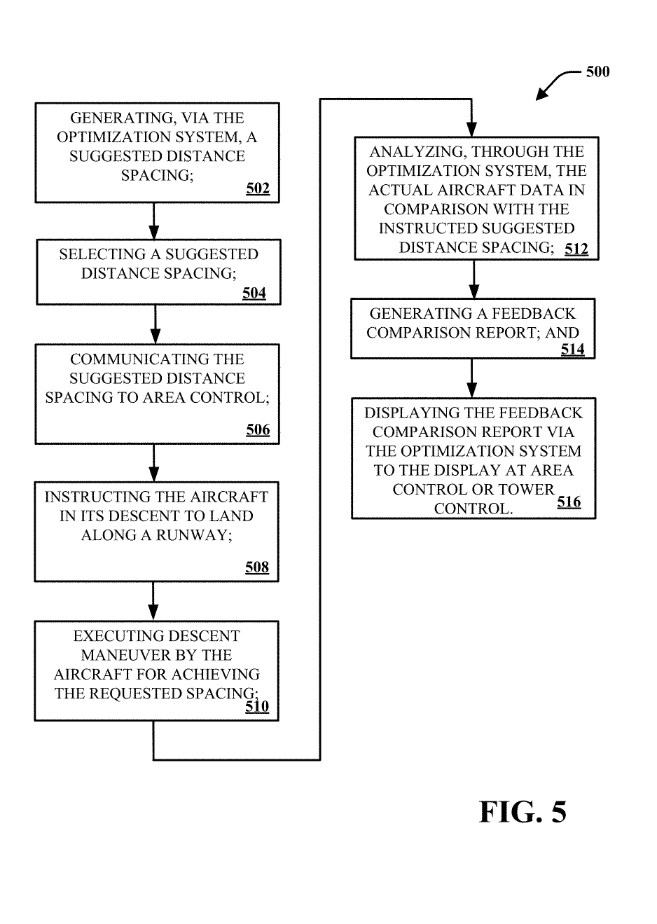

As illustrated by FIG. 5, the method for optimizing the spacing of arrival aircraft and departing aircraft along a runway may include the steps of generating, via an optimization system, at least one suggested distance spacing between at least one sequence of arriving and departing aircraft. Step 502. Selecting a suggested distance spacing. Step 504. Communicating the suggested distance spacing to an area control. Step 506. Instructing an aircraft in its decent to a runway. Step 508. Executing a descent maneuver for achieving the requested spacing. Step 510. Tracking actual aircraft data by the optimization system. Analyzing, through the optimization system, the actual aircraft data and comparing to the instructed suggested distance spacing. Step 512. Generating a feedback comparison report. Step 514. Displaying the feedback comparison report via the optimization system 300 to the display at the area control or tower control.

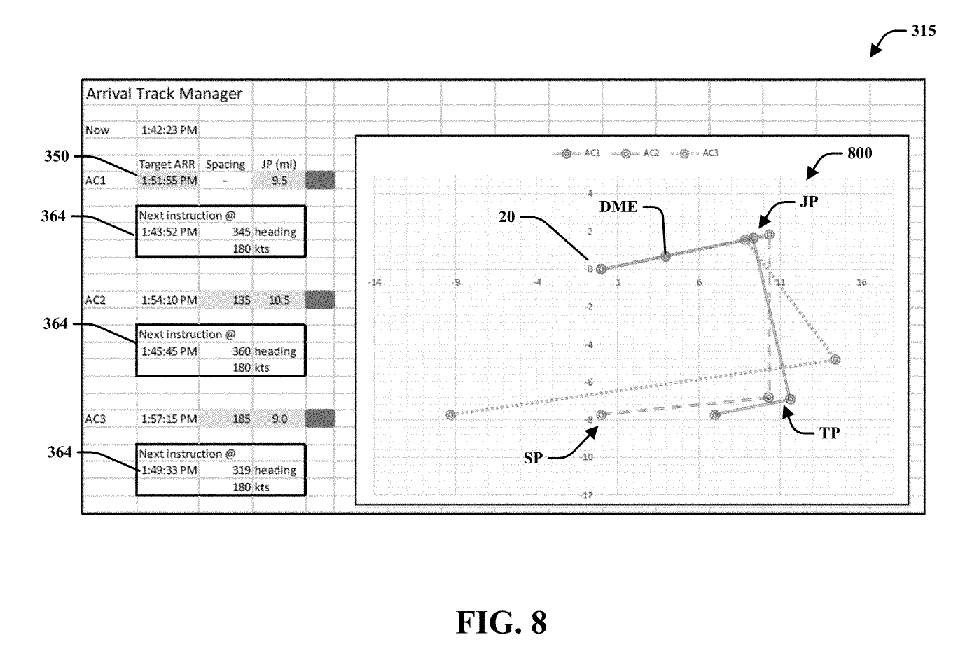

In another embodiment, as illustrated by FIG. 8, the optimization system 300 may allow for the live analysis of arrival aircraft with respect to a targeted arrival time for arriving aircraft, flight track via a specified way point, adherence to standard operating procedures, and airborne queuing times. The optimization system 300 may utilize data monitored and stored by the central database 310 to calculate suggested operating parameters to maximize the utilization of the airspace and the runway. The input signal 350 may be representative of a targeted arrival time that is illustrated on the graphical user interface 315.

The aircraft related data may be utilized to determine flight instructions which may be predicted to a high degree of accuracy. The system may also be utilized for delivering consistent and targeted arrival times of various aircraft by (i) selecting an arrival time, (ii) analyzing the aircraft related data to determine desired final approach line, (iii) instructing the pilot in its descent (iv) and executing the instruction by the pilot for achieving the target arrival time. As such, directions may be communicated to the aircraft to ensure it passes a defined way point and at what time the aircraft is desired to land. An optimal flight pattern may be determined that satisfies these constraints. In this way, optimization may also specify landing times of a sequence of arriving aircraft. The disclosed system may improve the communication, tracking, and implementation of these variables by ensuring that the tower controllers, area controllers and aircraft personnel adhere to a generated and trackable set of directions communicated and followed by each party.

FIG. 8 illustrates an example of a graph with aircraft related data that represents a plurality of final approach lines 800 for a plurality of aircraft in accordance with one embodiment of the present disclosure. The graph includes a coordinate system having lines that represent the trajectory of three (3) aircraft AC1, AC2, and AC3. The origin of the graph represents the airport/landing strip 20 and each of the plot points along the lines represent a way point including the distance measurement equipment point DME, a joining point JP, a turning point TP, and a starting point SP. Under the arrival track manager column, each aircraft is provided with a target arrival time. The target arrival time (Target ARR) may be an input signal 350 provided to the system by personnel at area control AC or tower control TC. The way points may also be an input signal 350.

In this embodiment, the optimization system processor 320 and central database 310 may analyze variables including the target arrival time and various other data 330, 340, 390, 392, 394 and generate an output signal 360 representative of flight instructions 364 to provide to the plurality of aircraft. The flight instruction 364 may include a time to provide the instructions, a target speed (illustrated as 180 kts), and target trajectory (illustrated as 345 heading) that may be estimated to achieve the target arrival time for the respective approaching aircraft. This output signal 360 representative of flight instructions 364 may then be illustrated on the graphical user interface 315 presented on the display 202A to be accessed by personnel at tower control TC or the display 202B to be accessed by personnel at area control AC. However, the output signal 360 is not limited to how it is communicated to either tower control TC and area control AC.

Under the arrival track manager column, the “spacing” identifies the time (in seconds) between subsequent aircraft AC1, AC2, and AC3 as each aircraft is traveling along the approach lines 800. The “spacing” information may also be an input signal 350 provided by tower control TC or area control AC. Further, the joining point JP along each approach line represents a location of the respective aircraft at the time the aircraft has entered into a desired final approach line in periphery of the airport 20. The turning point TP illustrates a known reference point along the trajectory of the flight pattern of the respective aircraft and the starting point SP is the current location of the aircraft. The joining point JP, spacing, and target arrival ARR may be input signals 350 that are utilized to generate the instructions that are communicated to aircraft. As aircraft personnel follow the instructions, the respective aircraft are to arrive at the target arrival time ARR.

The airport runway optimization system may allow the user to select a target arrival time for at least one aircraft, along with at least one way point which the aircraft is to traverse or pass near. As illustrated by FIG. 8, the way points may the joining point JP, turning point TP, starting point SP, or DME but may also include other geographical points. The choice of the way point or way points may be made to control the location of the aircraft to avoid an exclusion zone. An exclusion zone may be a defined geographic area in which there is a desire to mitigate aircraft traffic and that may reduce aircraft noise within the zone. The system allows for the management of aircraft to avoid targets and provide noise control while pre-calculating an arrival trace with a target arrival time as aircraft passes designated way points.

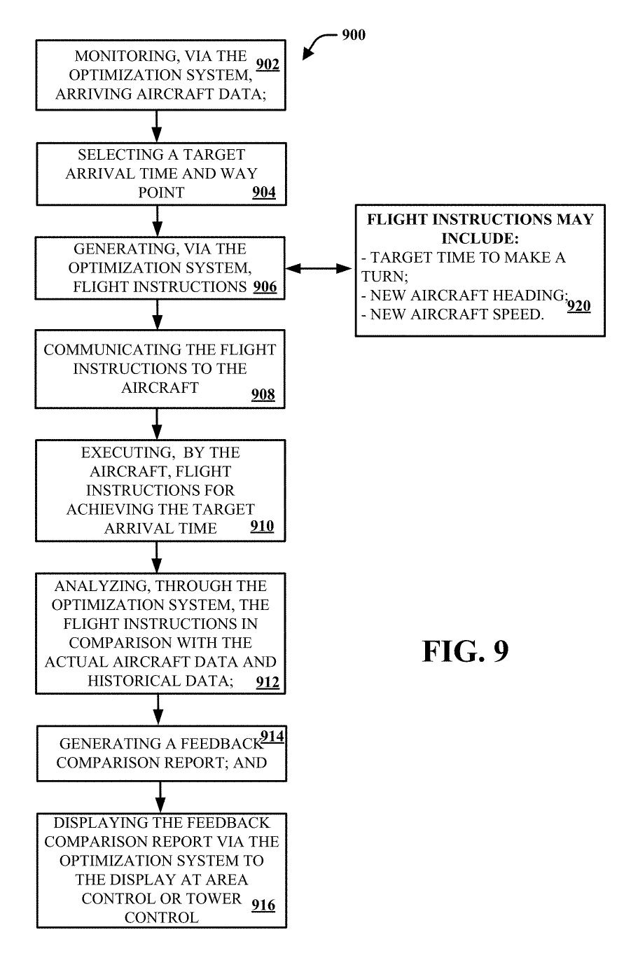

As illustrated by FIG. 9, a method for optimizing arrival aircraft along a runway is provided. The method includes monitoring, via the optimization system, arriving aircraft data in step 902. Selecting a target arrival time and way point for at least one aircraft in step 904. Generating, via an optimization system, flight instructions for achieving the target arrival time for the at least one arriving aircraft in step 906. The flight instructions 920 may include a target time to make a turn, and a new aircraft heading and speed. The flight instructions may then be communicated to the at least one aircraft in step 908. The aircraft then executes the flight instructions for achieving the target arrival time 910.

In one embodiment, the method includes analyzing, through the optimization system, the flight instructions in comparison with the actual aircraft data and historical data in step 912. A feedback comparison report may be generated in step 914. The feedback report may be displaced via the optimization system at area control AC or tower control TC.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A system for optimizing the spacing and timing of arrival aircraft and departing aircraft along a runway, the optimization system comprises:
a communication framework for communicating between a tower control, an area control, and a plurality of aircraft;
a processor for generating a suggested distance spacing between at least one sequence of arriving aircraft and departing aircraft;
a central database for monitoring arriving aircraft data and departing aircraft data, the central database is in communication with the processor; and
a graphical user interface for receiving input signals and displaying output signals,
wherein the processor generates the suggested distance spacing and displays the suggested distance spacing on the graphical user interface.

2. The system of claim 1, wherein the suggested distance spacing is selected by tower control and communicated to area control.

3. The system of claim 2, wherein area control receives the suggested distance spacing from tower control and directs at least one aircraft in its descent towards the runway.

4. The system of claim 1, wherein the at least one sequence of arriving aircraft and departing aircraft is Arriving-Departing-Arriving (ADA).

5. The system of claim 1, wherein the at least one sequence of arriving aircraft and departing aircraft is Arriving-Departing-Departing-Arriving (ADDA).

6. The system of claim 1, wherein the at least one sequence of arriving aircraft is Arriving-Arriving (AA).

7. The system of claim 1, wherein the processor analyzes actual aircraft data in comparison to the suggested distance spacing and generates a feedback comparison report on the graphical user interface.

8. A method for optimizing the spacing of arrival aircraft and departing aircraft along a runway, the method comprising:
generating, via an optimization system, at least one suggested distance spacing between at least one sequence of arriving and departing aircraft;
selecting a suggested distance spacing;
communicating the suggested distance spacing to an area control; and
instructing an aircraft to begin descent to land along a runway or to take-off from the runway.

9. The method of claim 7 wherein the optimization system includes a communication framework for communicating between a tower control, an area control, and a plurality of aircraft, a processor for generating the suggested distance spacing, a central database for monitoring arriving aircraft data and departing aircraft data, the central database is in communication with the processor; and a graphical user interface for receiving input signals and displaying output signals.

10. The method of claim 7, further comprises:
tracking actual aircraft data;
analyzing, through the optimization system, an actual aircraft data as comparing to the suggested distance spacing; and
generating a feedback comparison report.

11. A system for optimizing the arrival of aircraft along a runway, the optimization system comprises:
a communication framework for communicating between a tower control, an area control, and a plurality of aircraft;
a processor for generating flight instructions estimated to achieve a target arrival time for at least one arriving aircraft, with the constraint that the flight track passes near a pre-defined way point;
a central database for monitoring arriving aircraft data and departing aircraft data, the central database is in communication with the processor; and
a graphical user interface for receiving input signals and displaying output signals,
wherein the processor generates the flight instructions and displays arriving aircraft data on the graphical user interface.

12. The system of claim 11, wherein the target arrival time is selected by tower control and communicated to area control.

13. The system of claim 12, wherein area control communicates the flight instructions to at least one aircraft.

14. The system of claim 11, wherein the at least one sequence of arriving aircraft and departing aircraft is Arriving-Departing-Arriving (ADA).

15. The system of claim 11, wherein the at least one sequence of arriving aircraft and departing aircraft is Arriving-Departing-Departing-Arriving (ADDA).

16. The system of claim 11, wherein the at least one sequence of arriving aircraft is Arriving-Arriving (AA).

17. The system of claim 11, wherein the processor analyzes actual aircraft data in comparison to the flight instructions and generates a feedback comparison report on the graphical user interface.

18. A method for optimizing arrival aircraft along a runway, the method comprising:
monitoring arriving aircraft data;
selecting a target arrival time for at least one aircraft;
selecting a way point;
generating, via an optimization system, flight instructions for achieving the target arrival time for the at least one arriving aircraft; and
communicating the flight instructions to the at least one aircraft.

19. The method of claim 18 wherein the optimization system includes a communication framework for communicating between a tower control, an area control, and a plurality of arriving aircraft, a processor for generating the flight instructions, a central database for monitoring arriving aircraft data, the central database is in communication with the processor; and a graphical user interface for receiving input signals and displaying output signals.

20. The method of claim 18, further comprises:
analyzing, through the optimization system, an actual aircraft data as comparing to the flight instructions; and
generating a feedback comparison report.
